(19) United States
(12) Patent Application Publication
(10) Pub. No.: US 2015/0301632 A1
(43) Pub. Date: Oct. 22, 2015

(54) TOUCH PANEL SUBSTRATE AND DISPLAY DEVICE

(71) Applicant: Sharp Kabushiki Kaisha, Osaka-shi (JP)

(72) Inventor: Mitsuaki HIRATA, Osaka-shi (JP)

(21) Appl. No.: 14/417,830

(22) PCT Filed: Jul. 26, 2013
(86) PCT No.: PCT/JP2013/070366

§ 371 Date: Jan. 28, 2015

(30) Foreign Application Priority Data
Aug. 2, 2012 (JP) 2012-172406

(51) Int. Cl. G06F 3/041

(52) U.S. Cl. CPC G06F 3/041

(57) ABSTRACT

In order to provide a touch panel substrate in which a deterioration in display quality is prevented, the touch panel substrate is configured such that one of diagonal lines of a single grid that forms a grid shape of a first conductor line (217) is inclined by θ degrees with respect to a first direction, the other of the diagonal lines is inclined by θ degrees with respect to a direction vertical to the first direction, and in a plan view, a first connection section pattern (224) having a grid shape is located inside a second connection section pattern (234) having a grid shape.

### TECHNICAL FIELD

The present invention relates to a touch panel substrate and a display device including the touch panel substrate.

### BACKGROUND ART

In recent years, a display device has been widespread in which a display section is integrated with an input section so that the display device becomes smaller in size. Particularly, a display device including a touch panel is widely used in a mobile terminal such as a mobile phone, a PDA (Personal Digital Assistant), and a notebook personal computer. Such a touch panel is capable of detecting a contact position when a finger or an input pen (detection target) makes contact with a display surface.

Conventionally, there are known various types of touch panels such as, what are called, a resistance-film (pressure-sensitive) type touch panel and a capacitance type touch panel. Among such touch panels, the capacitance type touch panel is widely used.

In the capacitance type touch panel, a change in capacitance is detected when a finger or an input pen makes contact with a display screen, so that a contact position on the display screen is detected. Accordingly, the contact position can be detected by a simple operation.

What is called a sensor electrode which is a position detection electrode that detects a contact position of an object is likely to be made of ITO (indium tin oxide) or the like. However, in a case of a touch panel having a large screen, a problem arises that the sensor electrode made of ITO has a large resistance, so as to cause deterioration in sensitivity of detection.

Patent Literatures 1 and 2 each disclose a configuration in which sensor electrodes are each constituted by a grid-shaped metal wire so that a resistance of each of the sensor electrodes is reduced. The sensor electrodes are each configured such that a plurality of grid electrodes, each of which is divided into parts each having a square shape, are arranged in a row so that a sensor electrode extending in a longitudinal direction does not overlap with a sensor electrode extending in a transverse direction.

### CITATION LIST

### Patent Literatures

Patent Literature 1

Japanese Patent Application Publication, Tokukai, No. 2011-129501 A (Publication Date: Jun. 30, 2011)

Patent Literature 2

Japanese Patent Application Publication, Tokukai, No. 2010-039537 A (Publication Date: Feb. 18, 2010)

Patent Literature 3

Japanese Patent Application Publication, Tokukai, No. 2011-175412 A (Publication Date: Sep. 8, 2011)

### SUMMARY OF INVENTION

### Technical Problem

According to the conventional configuration, however, a grid-shaped metal wire may interfere with a black matrix of a display panel, so that a moire may occur. This may cause deterioration in display quality.

An occurrence of a moire relates to a pitch of wires formed in the touch panel and a pitch of pixels (a pitch of black matrix), in a longitudinal direction and a transverse direction. The pitch of black matrix is determined on the basis of a size of the display panel, a positional arrangement of pixels, and the like. Further, the occurrence of a moire also relates to a pitch of intersections of the wires formed in the touch panel and a pitch of a regular structure of the display panel (a TFT, a prism of a light guide plate, etc.).

Moreover, pitches of sensor electrodes arranged in the longitudinal direction and the transverse directions of the touch panel are determined as specifications on the basis of a size and a required performance (resolution) of the display panel. When the pitches of the sensor electrodes are determined, a size of an outer shape of a grid electrode of each of the sensor electrodes is also limited. A length which is obtained by dividing a length of a side of the grid electrode by the number of divisions of a grid of the grid electrode is a pitch of each of the grids (pitch of the wire). However, from a view point of performance (detection sensitivity), an aperture ratio, etc., there is a preferable range of the number of grid-shaped wires. Accordingly, a designer cannot determine the pitch of wires without limitation. According to the conventional configuration, therefore, a moire may occur.

The present invention has been made in view of the problems, and an object of the present invention is to provide (i) a touch panel substrate in which deterioration in display quality is prevented and (ii) a display device including the touch panel.

A further object of the present invention is to provide (i) a touch panel substrate in which deterioration in accuracy of position detection is prevented and (ii) a display device including the touch panel.

### Solution to Problem

In order to attain the object, a touch panel substrate of an embodiment in accordance with the present invention includes: a plurality of first detection electrodes each of which extends in a direction parallel to a first direction; and a plurality of second detection electrodes each of which extends in a direction parallel to a second direction which differs from the first direction, the plurality of first detection electrodes each including (i) a plurality of first grid electrodes which are arranged in a direction parallel to the first direction and each of which has an outer shape that is substantially quadrilateral and (ii) a first connection section which causes each adjacent ones of the plurality of first grid electrodes in the first direction to be connected to each other, the plurality of second detection electrodes each include (i) a plurality of second grid electrodes which are arranged in a direction parallel to the second direction and each of which has an outer shape that is substantially quadrilateral and (ii) a second connection section which causes each adjacent ones of the plurality of second grid electrodes in the second direction to be connected to each other, the plurality of first grid electrodes each including a first conductor line having a grid shape, the plurality of second grid electrodes each including a second conductor line having a grid shape, one of diagonal lines of a single grid that forms the grid shape of the first conductor line being inclined by θ degrees with respect to the first direction, the other of the diagonal lines being inclined by θ degrees with respect to a direction vertical to the first direction, one of diagonal lines of a single grid that forms the grid shape of the second conductor line being inclined by θ degrees with respect to the second direction, the other of the diagonal lines being inclined by θ degrees with respect to a direction vertical to the second direction, a first connection section pattern which has a grid shape and includes a conductor line being provided in the first connection section, a second connection section pattern which has a grid shape and includes a conductor line being provided in the second connection section, in a plan view, the first connection section pattern being located inside the second connection section pattern.

### Advantageous Effects of Invention

According to an aspect of the present invention, it is possible to provide a touch panel substrate which is used for a touch panel whose display quality is improved.

Further, it is possible to provide a touch panel substrate in which accuracy of detection of a detection target is improved.

### BRIEF DESCRIPTION OF DRAWINGS

FIG. 1 is a cross sectional view illustrating a schematic configuration of a display device in accordance with an embodiment of the present invention.

FIG. 2 is a plan view illustrating positional arrangements of first detection electrodes and second detection electrodes in a touch panel substrate of a reference example.

FIG. 3 is a plan view illustrating detailed configurations of the first detection electrodes of the reference example.

FIG. 4 is a plan view illustrating detailed configurations of the second detection electrodes of the reference example.

FIG. 5 is a plan view illustrating a configuration of a wire of a touch panel substrate of the reference example.

FIG. 6 is a view illustrating a display device in which a touch panel substrate and a display panel of the reference example are placed over each other.

FIG. 7 is a plan view illustrating a configuration of a wire of the touch panel substrate of the reference example.

FIG. 8 is a plan view illustrating a configuration of a wire of a touch panel substrate in accordance with an example of the present invention.

FIG. 9 is a plan view illustrating detailed configurations of first detection electrodes in accordance with an example of the present invention.

FIG. 10 is a plan view illustrating detailed configurations of second detection electrodes in accordance with an example of the present invention.

FIG. 11 is a plan view illustrating a configuration of a wire of the touch panel substrate in accordance with an example of the present invention.

FIG. 12 is a plan view illustrating a configuration of a wire of a touch panel substrate in accordance with another embodiment of the present invention.

FIG. 13 is a plan view illustrating a detailed configuration of a first detection electrode in accordance with another embodiment of the present invention.

FIG. 14 is a plan view illustrating a detailed configuration of a second detection electrode in accordance with another embodiment of the present invention.

FIG. 15 is a plan view illustrating a configuration of a wire of the touch panel substrate in accordance with another embodiment of the present invention. (a) of FIG. 15 is a plan view illustrating configurations of wires of the first detection electrode and second detection electrode. (b) of FIG. 15 is an enlarged plan view illustrating an intersection area of the first detection electrode and the second detection electrode. (c) of FIG. 15 is an enlarged plan view illustrating a first connection section of the first detection electrode. (d) of FIG. 15 is an enlarged plan view illustrating a second connection section of the second detection electrode.

### DESCRIPTION OF EMBODIMENTS

### Embodiment 1

The following description will discuss a display device having a touch panel function of an embodiment in accordance with the present invention (hereinafter referred to as a display device).

<Configuration of Display Device>

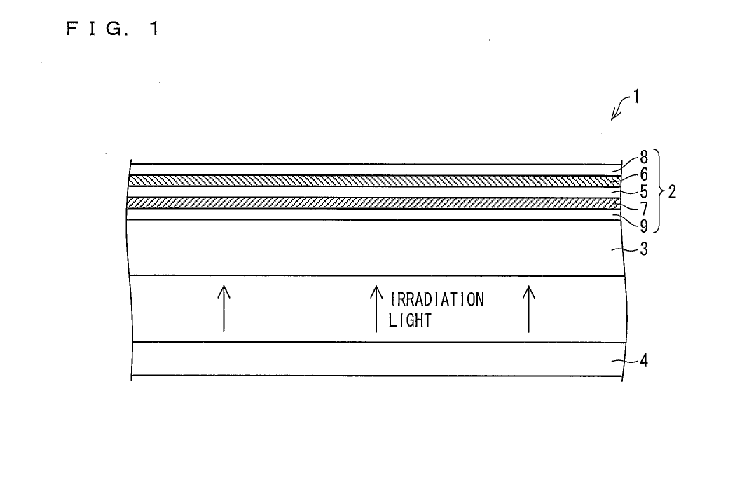

FIG. 1 is a cross sectional view illustrating a schematic configuration of a display device in accordance with the present embodiment. The display device 1 illustrated in FIG. 1 includes (i) a touch panel substrate 2, (ii) a display panel 3, (iii) various driving circuits (data signal line driving circuit, scanning signal line driving circuit, etc.; not illustrated) which drive the display panel 3, and (iv) a backlight 4.

(Display Panel and Backlight)

The display panel 3 is an active matrix type liquid crystal display panel in which a liquid crystal layer is sandwiched between an active matrix substrate and a color filter substrate.

The display panel 3 includes a black matrix (not illustrated) by which pixels are partitioned off from each other in a grid shape. A generally-used display panel can be employed as the display panel 3, and therefore a detailed description of a configuration of the display panel 3 is omitted. Further, the display panel 3 is not limited to a liquid crystal display panel. A given display panel such as an organic EL display can be employed as the display panel 3.

The backlight 4 is provided on a back surface side of the display panel 3 and emits light to the display panel 3.

(Touch Panel Substrate)

The touch panel substrate 2 is a capacitance type touch panel substrate which is provided on a front surface side (user side) of the display panel 3. The touch panel substrate 2 includes a substrate 5, a first electrode layer 6, a second electrode layer 7, a first protection layer 8, and a second protection layer 9. The first electrode layer 6 is provided on a front surface side of the substrate 5 and the second electrode layer 7 is provided on a back surface side of the substrate 5. The first protection layer 8 is provided on a front surface side of the first electrode layer 6. Further, the second protection layer 9 is provided on a back surface side of the second electrode layer 7.

The substrate 5 is constituted by a dielectric member and can be constituted by, for example, glass, a plastic film, or the like.

A plurality of first detection electrodes each of which is constituted by a conductor line, made of a metal or the like, having a low resistance are provided on the first electrode layer 6. The plurality of first detection electrodes each extend in a direction identical to a direction in which a scanning signal line extends (transverse direction: first direction).

A plurality of second detection electrodes each of which is constituted by a conductor line, made of a metal or the like, having a low resistance are provided on the second electrode layer 7. The plurality of second detection electrodes each extend in a direction orthogonal to a direction in which the plurality of first detection electrodes each extend (a direction in which a data signal line extends: longitudinal direction, second direction).

The first protection layer 8 (i) is a surface with which a detection target makes contact and (ii) can be constituted by a light transmissive insulator such as glass or a plastic film. Similarly, the second protection layer 9 can be also constituted by a light transmissive insulator such as glass or a plastic film. The second protection layer 9 is adhered to the display panel 3.

A capacitance is formed between a first detection electrode and a second detection electrode. When a detection target makes contact with a surface of the touch panel substrate 2, a change occurs in value of the capacitance. A contact position where the detection target has made contact with the surface of the touch panel substrate 2 can be specified by detecting the change in value of the capacitance. For example, when (i) a driving voltage is applied to the first detection electrode and (ii) a change in voltage of the second detection electrode is measured, a first detection electrode (row) and a second detection electrode (column) in each of which the value of the capacitance has changed are specified. In this case, the first detection electrode and the second detection electrode may also be referred to as a transmission electrode and a reception electrode, respectively. Note that a well-known circuit can be employed as a position detection circuit for detecting a position of coordinates of the detection target, and the position detection circuit is not particularly limited.

In a case where (i) detection electrodes in the longitudinal direction and the transverse direction are each formed by use of a grid-shaped light shielding metal wire and (ii) the grid-shaped metal wire is arranged, for example, at 0 degrees or 90 degrees with respect to a scanning signal line, a moire easily occurs. In a case where the grid-shaped metal wire is arranged at 45 degrees with respect to the scanning signal line, a moire is still likely to occur, although less likely as compared with the case where the grid-shaped metal wire is arranged at 0 degrees or 90 degrees with respect to the scanning signal line.

In view of the circumstances, one of methods of preventing an occurrence of a moire is to slightly incline the grid-shaped metal wire from 45 degrees with respect to the scanning signal line.

Note that a direction in which the detection electrodes in the transverse direction each extend is preferably along the scanning signal line. On the other hand, a direction in which the detection electrodes in the longitudinal direction each extend is preferably vertical to the scanning signal line. This is because in a case where the directions in which the detection electrodes extend are inclined, it becomes impossible to properly detect a contact position. Accordingly, the touch panel substrate cannot be inclined, together with the detection electrodes, with respect to the display panel so that the grid-shaped metal wire is inclined from 45 degrees.

The following description will discuss a reference example in which (i) the direction in which the detection electrodes extend is maintained parallel or vertical to the scanning signal line and (ii) the grid-shaped metal wire is slightly inclined from 45 degrees with respect to the scanning signal line.

### Reference Example

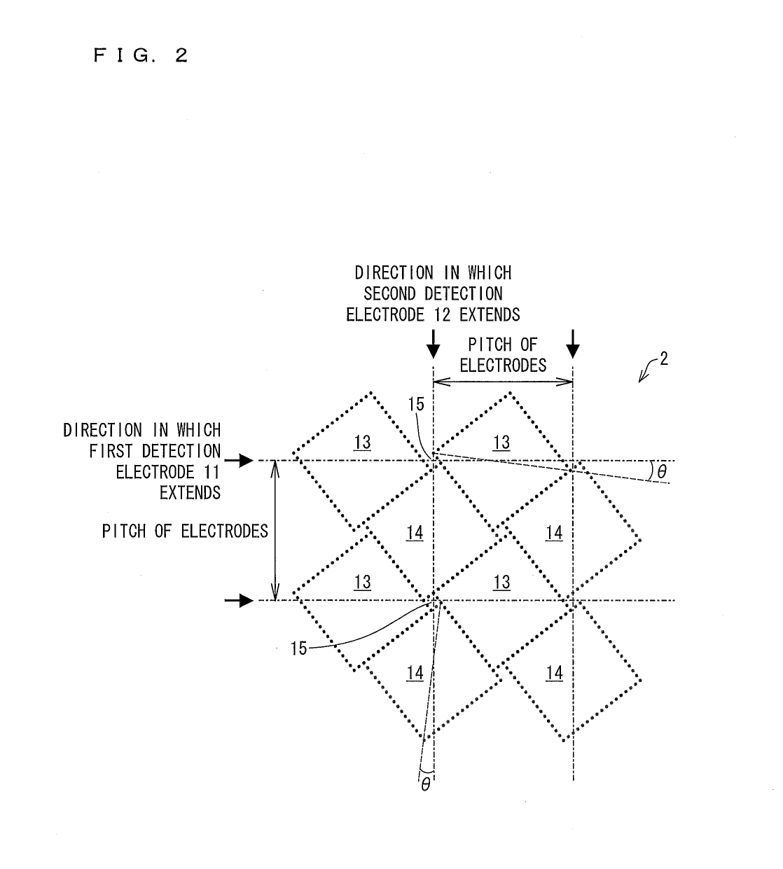

FIG. 2 is a plan view illustrating positional arrangements of first detection electrodes 11 and second detection electrodes 12 in a touch panel substrate 2 of a reference example. (i) A plurality of first grid electrodes 13 each of which has an outer shape that is square and (ii) a plurality of second grid electrodes 14 each of which has an outer shape that is square are arranged in the touch panel substrate 2. Note that the plurality of first grid electrodes 13 are provided in a layer different from a layer where the plurality of second grid electrodes 14 are provided.

A square indicating the outer shape of each of the plurality of first grid electrodes 13 (a region in which each of the plurality of first grid electrodes 13 is provided) and a square indicating the outer shape of each of the plurality of second grid electrodes 14 (a region in which each of the plurality of second grid electrodes 14 is provided) are uniformly inclined.

The plurality of first grid electrodes 13 and the plurality of second grid electrodes 14 are each constituted by a conductor line which has an outer shape that is a square grid shape. Since the conductor line is sufficiently thin, light emitted from the display panel can pass through the touch panel substrate 2.

The first detection electrodes 11 are identical to the second detection electrodes 12 in pitch. This allows position detection to be carried out with an identical accuracy in both of the longitudinal direction and the transverse direction. The pitch of the first detection electrodes 11 and the pitch of the second detection electrodes 12 are determined as specifications on the basis of a required performance (accuracy of detection, resolution of detection). The plurality of first grid electrodes 13 are arranged so as to be separated from each other. Further, the plurality of second grid electrodes 14 are arranged so as to be separated from each other.

FIG. 2 does not illustrate detailed configurations of the plurality of first grid electrodes 13 and the plurality of second grid electrodes 14. Note, however, that the plurality of first grid electrodes 13 which are arranged in the transverse direction so as to be separated from each other are electrically connected to each other via a connection wire. The connection wire is provided in a region 15 which (i) has a square shape and (ii) is located between the plurality of first grid electrodes 13. The first detection electrodes 11 each include a plurality of first grid electrodes 13 which are arranged in the transverse direction.

Further, the plurality of second grid electrodes 14 which are arranged in the longitudinal direction so as to be separated from each other are electrically connected to each other via another connection wire. The another connection wire is provided in a region 15 which (i) has a square shape and (ii) is located between the plurality of second grid electrodes 14. The second detection electrodes 12 each include a plurality of second grid electrodes 14 which are arranged in the longitudinal direction.

A diagonal line of each of the plurality of first grid electrodes 13 (a diagonal line connecting two opposite angles adjacent to respective regions 15) is inclined by θ degrees with respect to a direction in which the first detection electrodes 11 each extend (transverse direction). Similarly, a diagonal line of each of the plurality of second grid electrodes 14 (a diagonal line connecting two opposite angles adjacent to respective regions 15) is inclined by θ degrees with respect to a direction in which the second detection electrodes 12 each extend (longitudinal direction).

Note, however, that the plurality of first grid electrodes 13 are arranged along the direction in which the first detection electrodes 11 each extend, whereas the plurality of second grid electrodes 14 are arranged in the direction in which the second detection electrodes 12 each extend.

(First Detection Electrode)

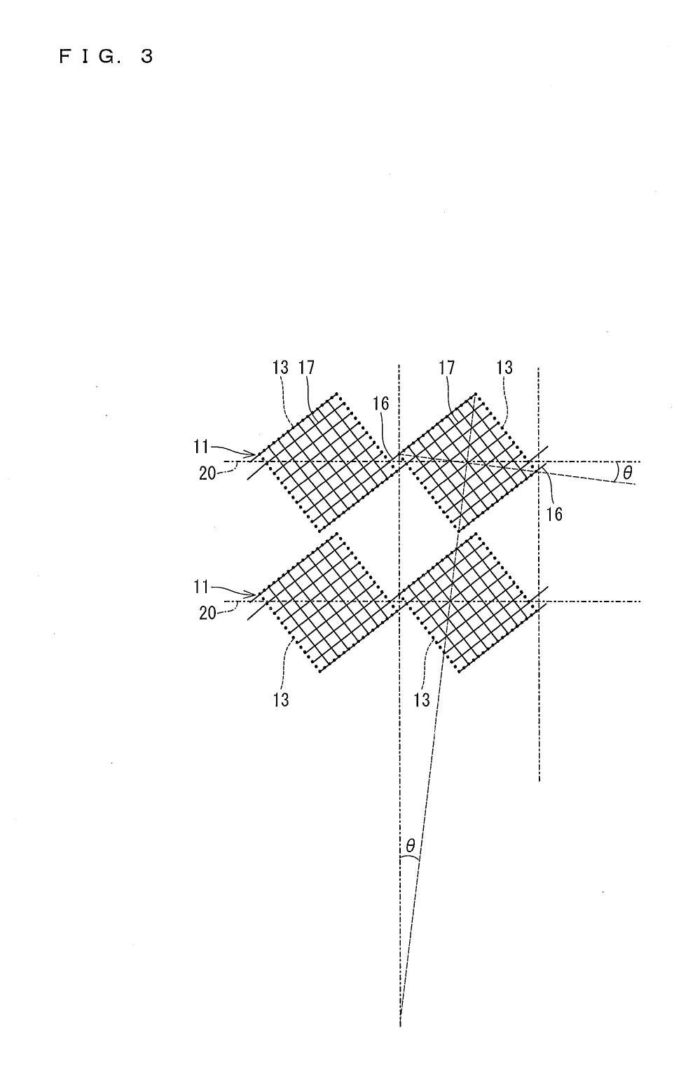

FIG. 3 is a plan view illustrating detailed configurations of the first detection electrodes 11 of the reference example. In FIG. 3, an outer shape of each of the plurality of first grid electrodes 13 is indicated by a dotted line, and a conductor line 17 constituting the each of the plurality of first grid electrodes 13 is indicated by a solid line.

The first detection electrodes 11 each extend in the transverse direction and have a plurality of first grid electrodes 13. Each adjacent ones, in the transverse direction, of the plurality of first grid electrodes 13 are separated from each other. A connection wire 16 which is constituted by a conductor line is provided between the each adjacent ones of the plurality of first grid electrodes 13. The each adjacent ones of the plurality of first grid electrodes 13 are connected to each other via the connection wire 16. Note that each adjacent ones, in the longitudinal direction, of the plurality of first grid electrodes 13 are separated from each other. The plurality of first grid electrodes 13 and the connection wire 16 are provided on an identical layer (the first electrode layer 6 illustrated in FIG. 1).

The conductor line 17 in each of the plurality of first grid electrodes 13 is formed so as to have a grid shape and be parallel along the outer shape of the each of the plurality of first grid electrodes 13. That is, the conductor line 17 is formed so as to be parallel to a side of the outer shape (square shape) of each of the plurality of first grid electrodes 13. In this case, since the plurality of first grid electrodes 13 each have a square shape, the conductor line 17 which constitutes each of the plurality of first grid electrodes 13 is arranged so as to have a square grid shape.

The conductor line 17 and the connection wire 16 are each made of a metal having a low resistance or the like. Note here that the connection wire 16 is provided in a position extended from a part of the conductor line (grid wire) 17 having a grid shape.

A diagonal line of each of the plurality of first grid electrodes 13 (a diagonal line connecting two opposite angles adjacent to respective connection wires 16) is inclined by θ degrees with respect to the direction in which the first detection electrodes 11 each extend (transverse direction).

That is, one of diagonal lines of a unit grid (a quadrilateral, which is a minimum unit) within the grid that forms each of the plurality of first grid electrodes 13 is inclined by θ degrees with respect to the direction in which the first detection electrodes 11 each extend (transverse direction).

Further, the other one of the diagonal lines of the unit grid (the quadrilateral, which is the minimum unit) within the grid that forms each of the plurality of first grid electrodes 13 is inclined by θ degrees with respect to the direction in which the second detection electrodes 12 each extend (longitudinal direction).

(Second Detection Electrode)

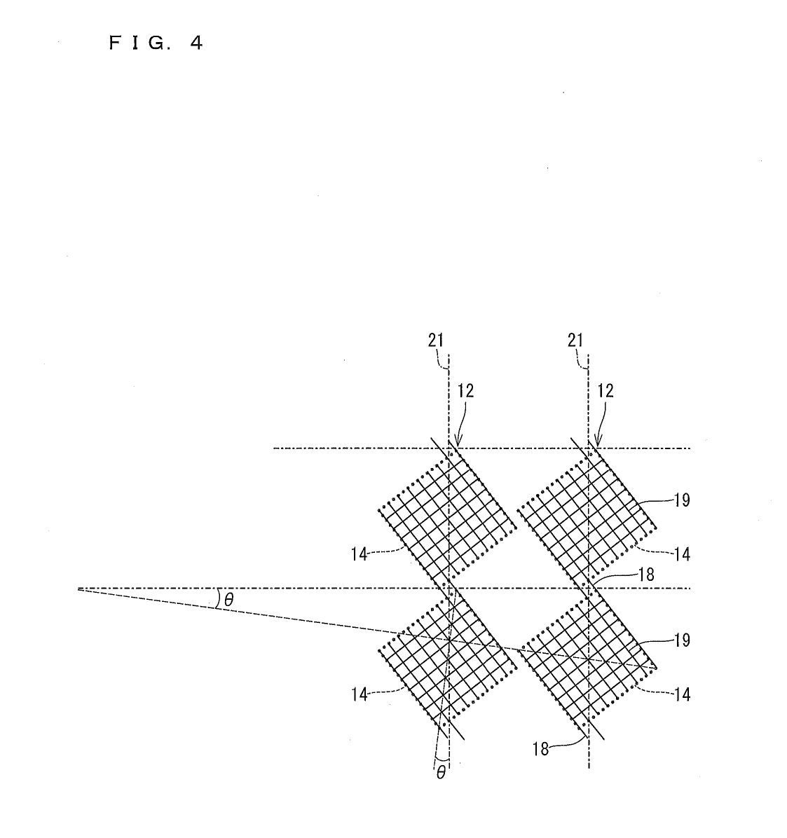

FIG. 4 is a plan view illustrating detailed configurations of the second detection electrodes 12 of the reference example. In FIG. 4, an outer shape of each of the plurality of second grid electrodes 14 is indicated by a dotted line, and a conductor line 19 constituting the each of the plurality of second grid electrodes 14 is indicated by a solid line. The second detection electrodes 12 each have a configuration identical to that of a first detection electrode 11 which is rotated by 90 degrees.

The second detection electrodes 12 each extend in the longitudinal direction and have a plurality of second grid electrodes 14. Each adjacent ones, in the longitudinal direction, of the plurality of second grid electrodes 14 are separated from each other. A connection wire 18 which is constituted by a conductor line is provided between the each adjacent ones of the plurality of second grid electrodes 14. The each adjacent ones of the plurality of second grid electrodes 14 are connected to each other via the connection wire 18. Note that each adjacent ones, in the transverse direction, of the plurality of second grid electrodes 14 are separated from each other. The plurality of second grid electrodes 14 and the connection wire 18 are provided on an identical layer (the second electrode layer 7 illustrated in FIG. 1).

The conductor line 19 in each of the plurality of second grid electrodes 14 is formed so as to have a grid shape and be parallel along the outer shape of the each of the plurality of second grid electrodes 14. That is, the conductor line 19 is formed so as to be parallel to a side of the outer shape (square shape) of each of the plurality of second grid electrodes 14. In this case, since the plurality of second grid electrodes 14 each have a square shape, the conductor line 19 which constitutes each of the plurality of second grid electrodes 14 is arranged so as to have a square grid shape.

The conductor line 19 and the connection wire 18 are each made of a metal having a low resistance or the like. Note here that the connection wire 18 is provided in a position extended from a part of the conductor line (grid wire) 19 having a grid shape.

A diagonal line of each of the plurality of second grid electrodes 14 (a diagonal line connecting two opposite angles adjacent to respective connection wires 18) is inclined by θ degrees with respect to the direction in which the second detection electrodes 12 each extend (longitudinal direction).

That is, one of diagonal lines of a unit grid (a quadrilateral, which is a minimum unit) within the grid that forms each of the plurality of second grid electrodes 14 is inclined by θ degrees with respect to the direction in which the second detection electrodes 12 each extend (longitudinal direction).

Further, the other one of the diagonal lines of the unit grid (the quadrilateral, which is the minimum unit) within the grid that forms each of the plurality of second grid electrodes 14 is inclined by θ degrees with respect to the direction in which the first detection electrodes 11 each extend (transverse direction).

(Countermeasure for Moire)

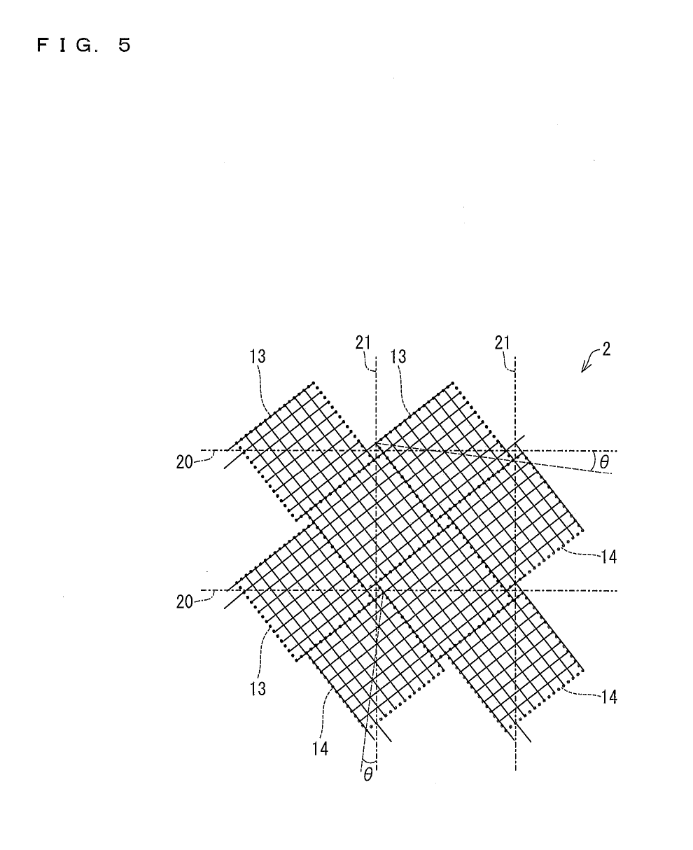

FIG. 5 is a view illustrating a state where the first detection electrodes 11 illustrated in FIG. 3 overlap with the second detection electrodes 12 illustrated in FIG. 4. FIG. 5 is a plan view illustrating a configuration of a wire of the touch panel substrate 2. In a state where the first detection electrodes 11 overlap with the second detection electrodes 12, a uniform grid pattern is formed on an entire part of the touch panel substrate 2 (a predetermined region in which detection electrodes are formed).

Further, (i) the conductor line 17 of each of the first detection electrodes 11 and (ii) the conductor line 19 of each of the second detection electrode are arranged not to overlap with each other on an identical line. This makes it difficult for a user to visually recognize patterns of the first detection electrodes 11 and the second detection electrodes 12, and thus prevents deterioration in display quality.

The direction in which the first detection electrodes 11 each extend (transverse direction) is orthogonal to the direction in which the second detection electrodes 12 each extend (longitudinal direction).

As described above, the diagonal line of the unit grid (the quadrilateral, which is the minimum unit) within the grid that forms (i) each of the plurality of first grid electrodes 13 or (ii) each of the plurality of second grid electrodes 14 is inclined with respect to both of the direction in which the first detection electrodes 11 each extend (transverse direction) and the direction in which the second detection electrodes 12 each extend (longitudinal direction).

One of two diagonal lines of the grid is inclined by θ degrees (0°<θ<45°) with respect to either one of the direction in which the first detection electrodes 11 each extend (transverse direction) or the direction in which the second detection electrodes 12 each extend (longitudinal direction).

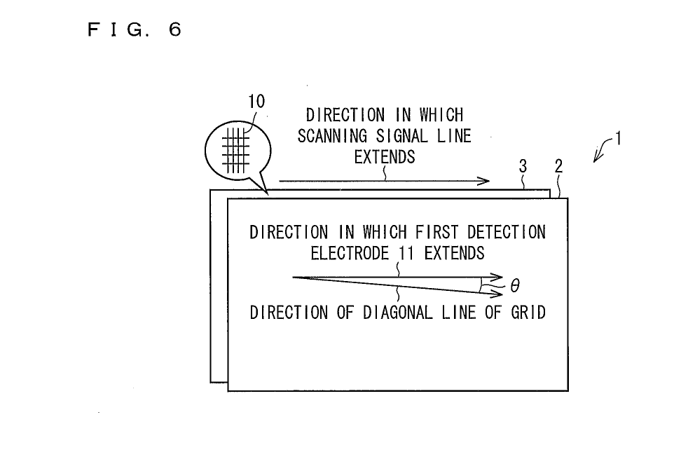

FIG. 6 is a view illustrating a display device 1 in which the touch panel substrate 2 and a display panel 3 are placed over each other.

A black matrix 10 which has a grid shape and by which pixels are partitioned off from each other is formed on the display panel 3. The black matrix 10 is constituted by a light shielding member.

One direction of arrangement of the grid of the black matrix which is formed in matrix on the display panel 3 is parallel to the direction in which the first detection electrodes 11 each extend (transverse direction). A line extending in the other direction of the arrangement of the grid is parallel to the direction in which the second detection electrodes 12 each extend (longitudinal direction).

Further, a scanning signal line extends in the transverse direction.

In the touch panel substrate 2, the first detection electrodes 11 each extend in the transverse direction, whereas the second detection electrodes 12 each extend in the longitudinal direction. On the other hand, one of the diagonal lines of the grid in the touch panel substrate 2 is inclined by θ degrees with respect to the direction in which the first detection electrodes 11 each extend.

That is, a direction in which a conductor line having a grid shape extends is inclined by θ degrees with respect to an angle that is inclined by 45 degrees from a direction in which the scanning signal line extends.

This allows a display device in which the touch panel substrate 2 is employed to more prevent an occurrence of a moire, as compared with a conventional display device in which a grid-shaped metal wire is arranged so as to be inclined by 45 degrees with respect to (i) the direction in which the scanning signal line extends and (ii) a direction in which the black matrix extends.

The reference example is an example of a case where the following conditions (1) through (3) are satisfied: (1) the conductor line having a grid shape is inclined with respect to an angle that is inclined by 45 degrees from the scanning signal line, (2) each adjacent ones of the plurality of first grid electrodes 13 are connected to each other via the connection wire 16 including two wires (i.e., the connection wire has a size identical to that of each unit grid) (the same applies to the plurality of second grid electrodes 14), and (3) the plurality of first grid electrodes 13 and the plurality of second grid electrodes 14 form a uniform grid of conductor lines in the touch panel substrate 102 as illustrated in FIG. 5. The condition (1) is a condition for reducing a moire. The condition (2) is a condition for causing the touch panel to function even in a case where the connection wire is partially broken. The condition (3) is a condition for uniformizing a brightness of an entire display screen.

In order for a touch panel substrate including grid electrodes each of which has a diamond shape (square shape) to satisfy the conditions (1) through (3), the following equation needs to be satisfied.

Degree of grid wire=45°±arctan(1/m) (1)

where m indicates the number of divisions of the grid of each of the grid electrodes, and is a natural number not smaller than 2. Along a side of an outer shape of each of the grid electrodes, m unit grids which are divided by grid wires are arranged. In the reference example illustrated in FIGS. 3 through 5, for example, the number of divisions m is 8. θ illustrated in FIG. 5 corresponds to arctan (1/m). In a case where the grid wires are each inclined by an angle of 45 degrees to arctan (1/m), a single unit grid into which the grid is divided has a size identical to that of the region 15 (see FIG. 2) in which a connection wire is formed.

Further, the angle of the grid wire is an angle of a group of wires of the grid wire with respect to the scanning signal line, the group of wires extending in one direction of the grid wire. Another group of wires of the grid wire, which group of wires extend in the other direction of the grid wire, are vertical to the group of wires extending in the one direction of the grid wire. Note that the number of divisions m has a range suitable for a touch panel. For example, in a case where the number of divisions becomes too large, an area of wires is increased, so as to cause a reduction in transmittance of the touch panel substrate.

### Problem of Reference Example

The touch panel substrate 2 has a problem that an accuracy of a position detection of a detection target is low. The following description will specifically discuss this problem.

(Symmetry with Respect to Sensor Axis)

In the configuration of the reference example, the outer shape of each of the grid electrodes is not symmetric with respect to a sensor axis of the detection electrode. Note here that the sensor axis indicates a straight line which (i) is parallel to a direction in which the detection electrode extends and (ii) equally divides an area of each of the grid electrodes.

That is, as illustrated in FIG. 3, the outer shape of each of the plurality of first grid electrodes (i) is a straight line which is parallel to the direction in which the first detection electrodes 11 each extend and (ii) is not symmetric (linearly symmetric) with respect to the sensor axis 20 which is a straight line that equally divides an area of each of the plurality of first grid electrodes 13.

Further, as illustrated in FIG. 4, the outer shape of each of the plurality of second grid electrodes 14 (i) is a straight line which is in the direction in which the second detection electrodes extend and (ii) is not symmetric (linearly symmetric) with respect to the sensor axis 21 which is a straight line that equally divides an area of each of the plurality of second grid electrodes 14.

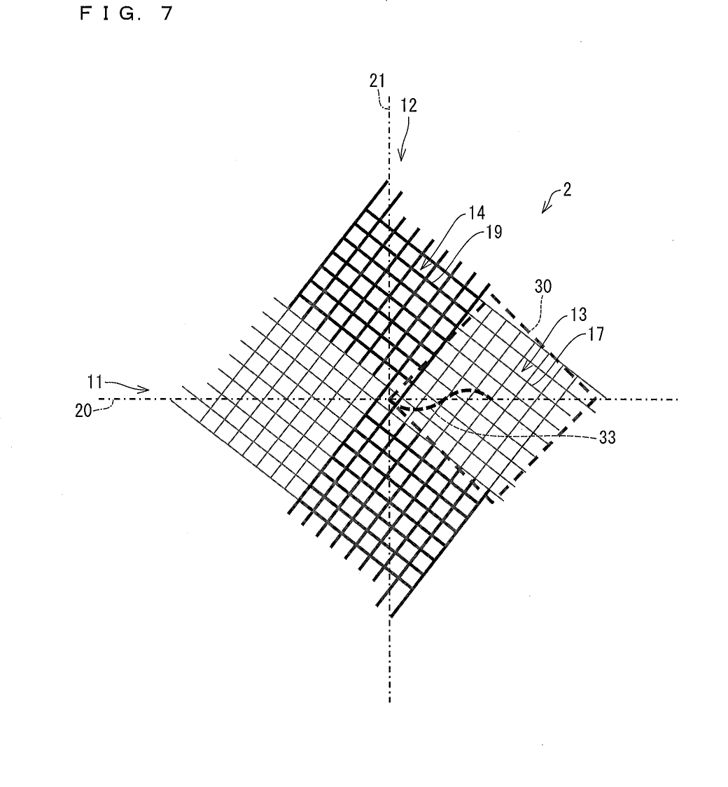

FIG. 7 is a plan view illustrating a configuration of wires of the touch panel substrate 2 of the reference example.

A square indicated by a wavy line in FIG. 7 is a reference square 30 which indicates an outer shape of one of adjacent square-shaped grid electrodes which are provided on a straight line so as to share vertices with each other.

The reference square 30 is a square having a diagonal line which is a segment connecting (i) an intersection of a sensor axis 20 and a first sensor axis 21 and (ii) an intersection of the sensor axis 20 and a second sensor axis 21 (not illustrated) which is adjacent to the first sensor axis 21.

That is, the reference square 30 is a diagram which is linearly symmetric with respect to the sensor axis 20.

A curved line indicated by a solid line in FIG. 7 is a symmetry degree index line 33 obtained by connecting middle points to each other, each of the middle points being a middle point of two intersections at which the outer shape of each of the first grid electrodes 13 intersects with a straight line vertical to the sensor axis 20.

That is, the symmetry degree index line 33 indicates a degree of symmetry, with respect to the sensor axis 20, of each of the plurality of first grid electrodes 13. In a case where the symmetry degree index line 33 is located on the sensor axis 20, the each of the first grid electrodes 13 is linearly symmetric with respect to the sensor axis 20.

As is easily understood by (i) referring to the symmetry degree index line 33 and (ii) comparing each of the plurality of first grid electrodes 13 with the reference square 30, each of the plurality of first grid electrodes 13 of the reference example does not have a shape symmetric (linearly symmetric) with respect to the sensor axis 20.

(Accuracy of Position Detection)

As illustrated above, the capacitance type touch panel substrate is configured such that a position where a detection target makes contact with a surface of the touch panel substrate can be detected on the basis of a change in capacitance formed between the first detection electrodes 11 and the second detection electrodes 12.

That is, the capacitance type touch panel substrate can detect a contact or a movement of the detection target on the surface of the touch panel substrate on the basis of a change in capacitance formed between (i) the plurality of first grid electrodes 13 of each of the first detection electrodes 11 and (ii) the plurality of second grid electrodes 14 of each of the second detection electrodes 12.

The capacitance formed between the plurality of first grid electrodes 13 and the plurality of second grid electrodes 14 is affected by an area (size) of each of the plurality of first grid electrodes 13.

The following description will discuss, as an example, a case where in a touch panel substrate having the configuration illustrated in FIG. 3, a detection target has moved, in a direction parallel to a direction in which a sensor axis 20 extends, between two first detection electrodes 11.

In the touch panel substrate of the reference example, the shape of each of the plurality of first grid electrodes 13 is not symmetric (linearly symmetric) with respect to the sensor axis 20. Accordingly, a capacitance (upper capacitance) which is formed between (i) a first grid electrode 13, illustrated in an upper part of FIG. 3, of a first detection electrode 11 and (ii) a second grid electrode 14 (not illustrated) may differ from a capacitance (lower capacitance) which is formed between (a) a first grid electrode 13 illustrated in a lower part of FIG. 3 and (b) a second grid electrode 14 (not illustrated).

More specifically, in a case where the detection target moves straight in a middle position of sensor axes 20 of the respective two first detection electrodes 11 and in the direction parallel to the direction in which the sensor axes 20 extend, the upper capacitance becomes larger than the lower capacitance or the lower capacitance becomes larger than the upper capacitance, depending on a position of the detection target.

A value of a capacitance detected affects a result of detection of the detection target. Accordingly, even in a case where the detection target moves straight along two sensor axes 20 in the middle position of the two sensor axes 20, it is erroneously detected that the detection target has moved in a zigzag manner between the two sensor axes 20.

Such erroneous detection also occurs similarly in a case of the second detection electrodes illustrated in FIG. 4.

Accordingly, in order to accurately carry out the position detection in the touch panel substrate, the grid electrodes each need to be symmetric with respect to the sensor axis.

### EXAMPLES

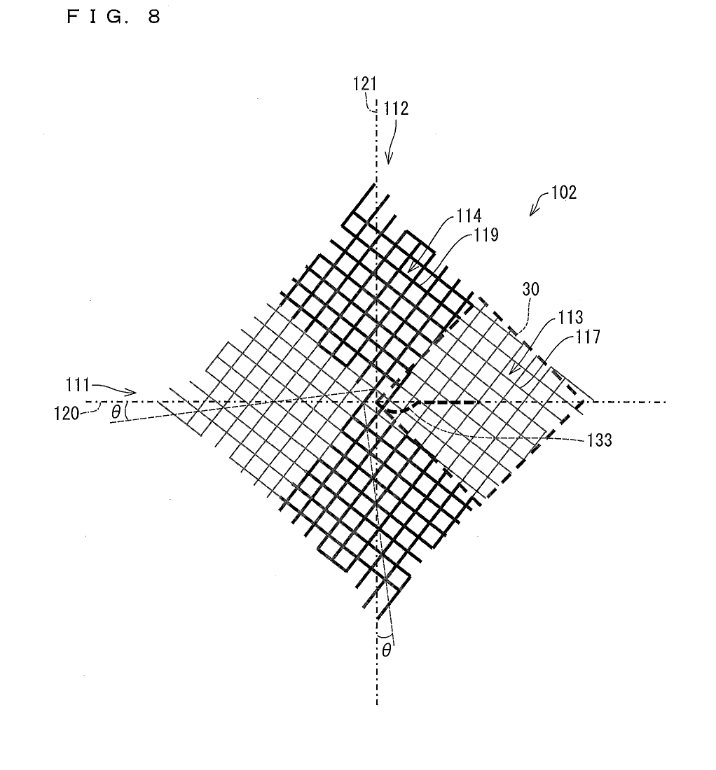

The following description will discuss, with reference to FIGS. 8 through 11, a touch panel substrate of an example of the present invention. Note that, for convenience of description, members which have functions identical to those described in the reference example are given identical reference numerals, and descriptions on such members will be omitted.

FIG. 8 is a plan view illustrating a configuration of a wire of a touch panel substrate 102 of the present example. As illustrated in FIG. 8, the touch panel substrate 102 of the present example includes (i) a first detection electrode 111 which extends in a direction parallel to a transverse direction in FIG. 8 (first direction) and (ii) a second detection electrode 112 which extends in a direction parallel to a longitudinal direction in FIG. 8 (second direction).

Further, the first detection electrode 111 includes a plurality of first grid electrodes 113 which are arranged along a sensor axis 120 (first electrode axis) extending in the direction parallel to the transverse direction in FIG. 8.

The second detection electrode 112 includes a plurality of second grid electrodes 114 which are arranged along a sensor axis 121 (second electrode axis) extending in the direction parallel to the longitudinal direction in FIG. 8.

According to the present example, the sensor axis 120 can be a straight line which equally divides an area of each of the plurality of first grid electrodes 113, whereas the sensor axis 121 can be a straight line which equally divides an area of each of the plurality of second grid electrodes 114.

The plurality of first grid electrodes 113 and the plurality of second grid electrodes 114 each have a substantially quadrilateral shape.

The plurality of first grid electrodes 113 each include a first conductor line 117 having a grid shape. Further, the plurality of second grid electrodes 114 each include a second conductor line 119 having a grid shape.

For convenience of description, in FIG. 8, the first conductor line 117 is indicated by a line thicker than a line indicating the second conductor line 119 so that the first conductor line 117 and the second conductor line 119 can be distinguished from each other. Note, however, that it is preferable that the first conductor line 117 and the second conductor line 119 are actually identical to each other in thickness. This applies to all of drawings described below.

(Countermeasure for Moire)

As illustrated in FIG. 8, according to the first detection electrodes 111 of the present example, as with a case of the touch panel substrate 2 of the reference example, one of diagonal lines of a unit grid (a quadrilateral, which is a minimum unit) that forms each of the plurality of first grid electrodes 113 is inclined by θ degrees with respect to a direction in which the first detection electrodes 111 each extend (a direction in which the sensor axis 120 extends).

Further, the other one of the diagonal lines of the unit grid (the quadrilateral, which is the minimum unit) within the grid that forms each of the plurality of first grid electrodes 13 is inclined by θ degrees with respect to a direction vertical to the direction in which the first detection electrodes 11 each extend (a direction in which the sensor axis 121 extends).

This allows a display device 1 including the touch panel substrate 102 of the present example to more prevent an occurrence of a moire, as compared with a conventional display device in which a grid-shaped metal wire is arranged so as to be inclined by 45 degrees with respect to (i) a direction in which a scanning signal line extends and (ii) a direction in which a black matrix extends.

(Symmetry with Respect to Sensor Axis)

Further, in the first detection electrodes 111 of the present example, symmetry, with respect to a sensor axis, of each of the plurality of first grid electrodes 113 is increased, as compared with the symmetry, with respect to the sensor axis, of each of the plurality of first grid electrodes 13 of the reference example.

The following description will specifically discuss this.

A part of the first conductor line 117 of each of the plurality of first grid electrodes 113 of the present example which part protrudes from the reference square 30 is smaller than a part of the conductor line 17 of each of the plurality of first grid electrodes 13 of the reference example which part protrudes from the reference square 30.

As is clear from a symmetry degree index line 133 illustrated in FIG. 8, the symmetry, with respect to the sensor axis, of each of the plurality of first grid electrodes 113 of the touch panel substrate 102 of the present example is higher than the symmetry, with respect to the sensor axis, of each of the plurality of first grid electrodes 13 of the reference example.

Although not illustrated, symmetry, with respect to the sensor axis, of each of the plurality of second grid electrodes 114 (not illustrated) of the touch panel substrate 102 of the present example is also higher than symmetry, with respect to the sensor axis, of each of the plurality of second grid electrodes 14 of the reference example.

<First Detection Electrode>

The following description will discuss in more detail the first detection electrode 111 of the present example.

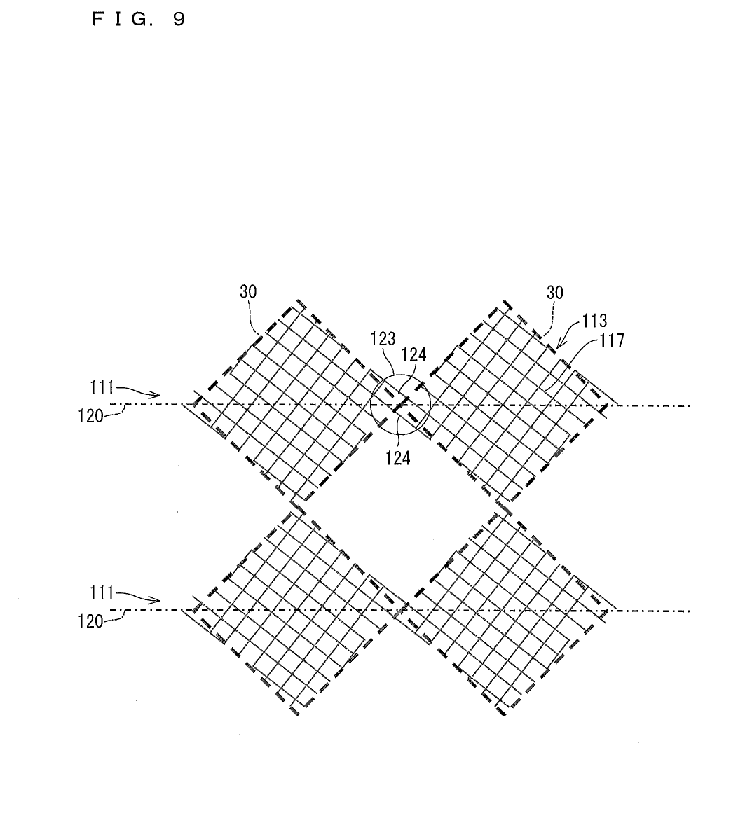

FIG. 9 is a plan view illustrating detailed configurations of the first detection electrodes 111 of the present example.

A square indicated by a wavy line in FIG. 9 is a reference square 30 which indicates an outer shape of one of grid electrodes each of which has a square shape, in a case where each adjacent ones of the grid electrodes are provided on a straight line so as to share vertices with each other.

A sensor axis 120 illustrated in FIG. 9 is a straight line which (i) is parallel to a direction in which the first detection electrodes 111 each extend and (ii) equally divides an area of the reference square 30. The sensor axis 120 passes through two vertices of the reference square 30.

The plurality of first grid electrodes 113 of the present example can be each configured to have a substantially square shape. A first conductor line 117 is provided on each of the plurality of first grid electrodes 113 so as to have a grid shape.

Each adjacent ones, in a direction in which the sensor axis 120 extends, of the plurality of first grid electrodes 113 are electrically connected to each other. The each adjacent ones of the plurality of first grid electrodes 113 are connected to each other via a connection section 123.

The connection section 123 indicates a part where the each adjacent ones of the plurality of first grid electrodes 113 are connected to each other. The connection section 123 includes a connection wire 124 (first connection wire). The connection wire 124 can be constituted by an extension of the first conductor line 117 which is extended to an outside of each of the plurality of first grid electrodes 113.

In other words, it can be considered that a part of the conductor line which part is located inside a region of the reference square 30 is the first conductor line 117 and the other part of the conductor line which part is located outside the region of the reference square 30 is the connection wire 124.

Further, in the first detection electrode 111 of the present example, the connection wire 124 is constituted by extending two first conductor lines 117. Two connection wires 124 are arranged so as to have, between the two connection wires 124, a vertex shared by reference squares 30 adjacent to each other (a center of the connection section 123).

<Second Detection Electrode>

The following description will discuss in more detail the second detection electrode 112 of the present example.

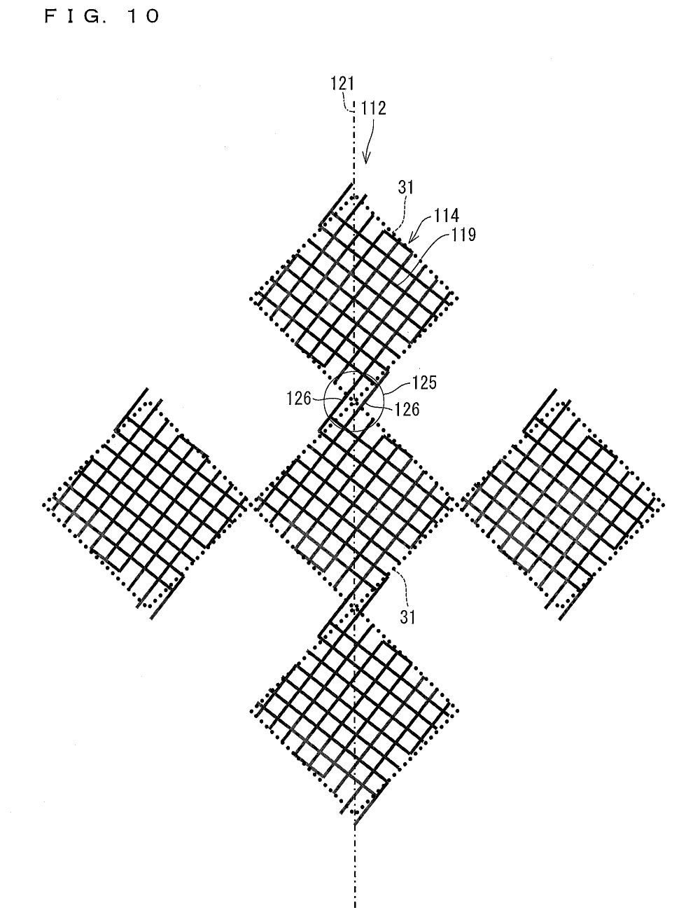

FIG. 10 is a plan view illustrating detailed configurations of the second detection electrodes 112 of the present example.

A square indicated by a dotted line in FIG. 10 is a reference square 31 which indicates an outer shape of one of grid electrodes each of which has a square shape, in a case where each adjacent ones of the grid electrodes are provided on a straight line so as to share vertices with each other.

A sensor axis 121 illustrated in FIG. 10 is a straight line which (i) is parallel to a direction in which the second detection electrodes 112 each extend and (ii) equally divides an area of the reference square 31. The sensor axis 121 passes through two vertices of the reference square 31.

The plurality of second grid electrodes 114 of the present example can be each configured to have a substantially square shape. A second conductor line 119 is provided on each of the plurality of second grid electrodes 114 so as to have a grid shape.

Each adjacent ones, in a direction in which the sensor axis 121 extends, of the plurality of second grid electrodes 114 are electrically connected to each other. The each adjacent ones of the plurality of second grid electrodes 114 are connected to each other via a connection section 125.

A connection section 125 indicates a part where the each adjacent ones of the plurality of second grid electrodes 114 are connected to each other. The connection section 125 includes a connection wire 126. The connection wire 126 can be constituted by an extension of the second conductor line 119 which is extended to an outside of each of the plurality of second grid electrodes 114.

In other words, it can be considered that a part of the conductor line which part is located inside a region of the reference square 31 is the second conductor line 119 and the other part of the conductor line which part is located outside the region of the reference square 31 is the connection wire 126.

Further, in the second detection electrode 112 of the present example, the connection wire 126 is constituted by extending two first conductor lines 119. Two connection wires 126 are arranged so as to have, between the two connection wires 126, a vertex shared by reference squares 31 adjacent to each other (a center of the connection section 125).

<Connection Section>

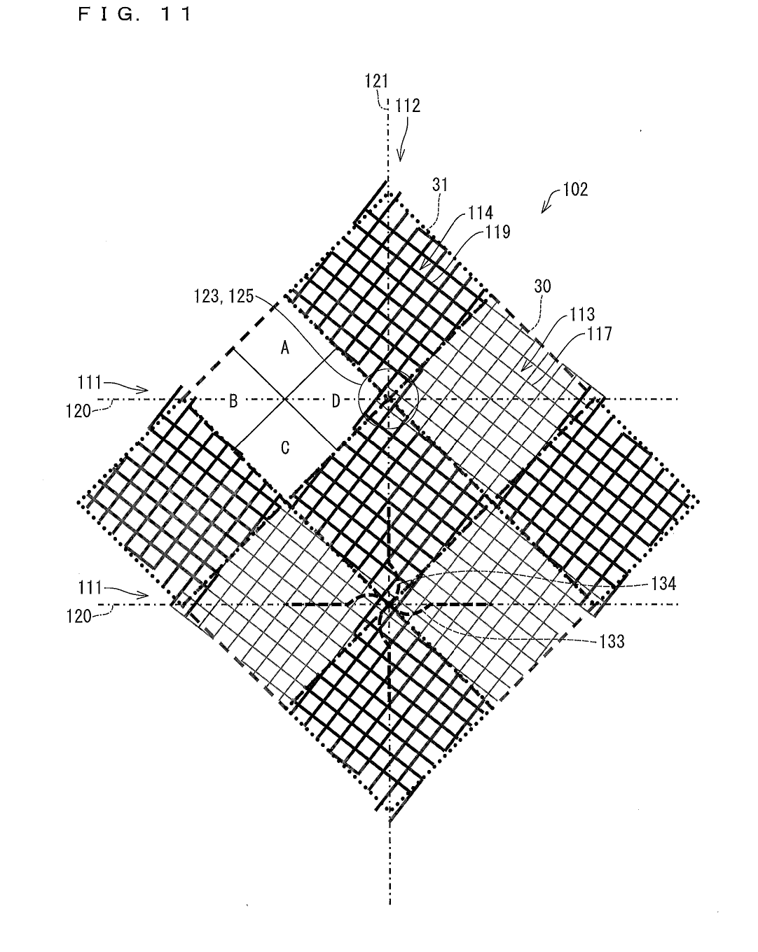

FIG. 11 is a plan view illustrating a configuration of a wire of the touch panel substrate 102 of the present example.

Note that, for convenience of description, no first conductor line 117 is illustrated in a part of first grid electrodes 113.

The touch panel substrate 102 of the present example includes an electrode which is obtained in a case where the first grid electrodes 113 illustrated in FIG. 9 and the second grid electrodes 114 illustrated in FIG. 10 are placed over each other.

When the first grid electrodes 113 and the second grid electrodes 114 are placed over each other, the connection section 123 overlaps with the connection section 125 in a plan view.

Further, near the connection section 123, a connection wire 126 which is extended from a second conductor line 119 overlaps, in a plan view, with a part of a region of a reference square 30. The first conductor line 117 is not arranged in the part.

Moreover, near the connection section 125, a connection wire 124 which is extended from a first conductor line 117 overlaps, in a plan view, with a part of a region of a reference square 31. The second conductor line 119 is not arranged in the part.

Such arrangements of the conductor lines prevent the conductor line of the first detection electrode 111 from overlapping, in a plan view, with the conductor line of the second detection electrode 112. This makes it possible to secure an electrical connection between the first grid electrodes 113 and an electrical connection between the second grid electrodes 114.

In a case where the conductor line of the first detection electrode 111 and the conductor line of the second detection electrode 112 are arranged as described above, it is possible to uniformize a transmittance of light in a detection surface of the touch panel substrate 102.

(Accuracy of Position Detection)

As described above, since the region of the reference square 30 has a part in which no first conductor line 117 is arranged, an outer shape of each of the plurality of first grid electrodes 113 does not exactly correspond to that of the reference square 30 near the connection section 123. However, other than near the connection section 123, the outer shape of each of the plurality of first grid electrodes 113 corresponds to that of the reference square 30.

That is, an edge of the first conductor line 117 is arranged to correspond to a shape of the reference square 30.

As described above, the reference square 30 is a diagram which (i) has a diagonal line on the sensor axis 120 and (ii) is linearly symmetric with respect to the sensor axis 120.

Accordingly, the reference square 30 has a pair of opposite angles that face each other across the sensor axis 120. The sensor axis 120 is an axis of symmetry for vertices of the pair of opposite angles.

Similarly, the outer shape of each of the plurality of first grid electrodes 113 has a pair of opposite angles that face each other across the sensor axis 120. Further, distances from the sensor axis 120 to respective vertices of the pair of opposite angles are identical to each other.

In other words, among four corners of the outer shape of each of the plurality of first grid electrodes 113 which outer shape is substantially quadrilateral, a region near the vertices of the pair of opposite angles which are not adjacent, in a direction of the sensor axis 120, to another first grid electrode 113 is symmetric with respect to the sensor axis 120.

Further, as illustrated in FIG. 11, in a case where a first grid electrode 113 is equally divided into regions of four substantial squares A through D, the regions of the squares A and C each of which includes a vertex which is not adjacent, in the direction of the sensor axis 120, to another first grid electrode 113 are symmetric to each other with respect to the sensor axis 120.

Similarly, since the region of the reference square 31 has a part in which no second conductor line 119 is arranged, an outer shape of each of the plurality of second grid electrodes 114 does not exactly correspond to that of the reference square 31 near the connection section 125. However, other than near the connection section 125, the outer shape of each of the plurality of second grid electrodes 114 corresponds to that of the reference square 31.

That is, an edge of the second conductor line 119 is arranged to correspond to a shape of the reference square 31.

As described above, the reference square 31 is a diagram which (i) has a diagonal line on the sensor axis 121 and (ii) is linearly symmetric with respect to the sensor axis 120.

Accordingly, the reference square 31 has a pair of opposite angles that face each other across the sensor axis 121. The sensor axis 121 is an axis of symmetry for vertices of the pair of opposite angles.

Similarly, the outer shape of each of the plurality of second grid electrodes 114 has a pair of opposite angles that face each other across the sensor axis 121. Further, distances from the sensor axis 121 to respective vertices of the pair of opposite angles are identical to each other.

In other words, among four corners of the outer shape of each of the plurality of second grid electrodes 114 which outer shape is substantially quadrilateral, a region near the vertices of the pair of opposite angles which are not adjacent, in a direction of the sensor axis 121, to another second grid electrode 114 is symmetric with respect to the sensor axis 121.

Further, in a case where a second grid electrode 114 is equally divided into regions of four substantial squares, the regions of the squares each of which includes a vertex which is not adjacent, in the direction of the sensor axis 121, to another second grid electrode 114 are symmetric to each other with respect to the sensor axis 121.

A curved line in FIG. 11 indicates a symmetry degree index line 133 which is obtained by connecting middle points to each other, each of the middle points being a middle point of two intersections of (i) the outer shape of each of the plurality of first grid electrodes 113 and (ii) a straight line vertical to the sensor axis 120.

Another curved line in FIG. 11 indicates a symmetry degree index line 134 which is obtained by connecting middle points to each other, each of the middle points being a middle point of two intersections of (i) the outer shape of each of the plurality of second grid electrodes 114 and (ii) a straight line vertical to the sensor axis 121.

As is clear from the symmetry degree index lines 133 and 134 illustrated in FIG. 11, the symmetry, with respect to the sensor axis, of each of (i) the plurality of first grid electrodes 113 and (ii) the plurality of second grid electrodes 114 is higher than the symmetry, with respect to the sensor axis, of each of (a) the plurality of first grid electrodes 13 and (b) the plurality of second grid electrodes 14 of the reference example.

In other words, the conductor line is configured such that a centroid of each of the plurality of grid electrodes becomes closer to the sensor axis.

This allows the touch panel substrate 102 of the present example to more accurately detect a position of a detection target, as compared with the touch panel substrate 2 of the reference example.

### Embodiment 2

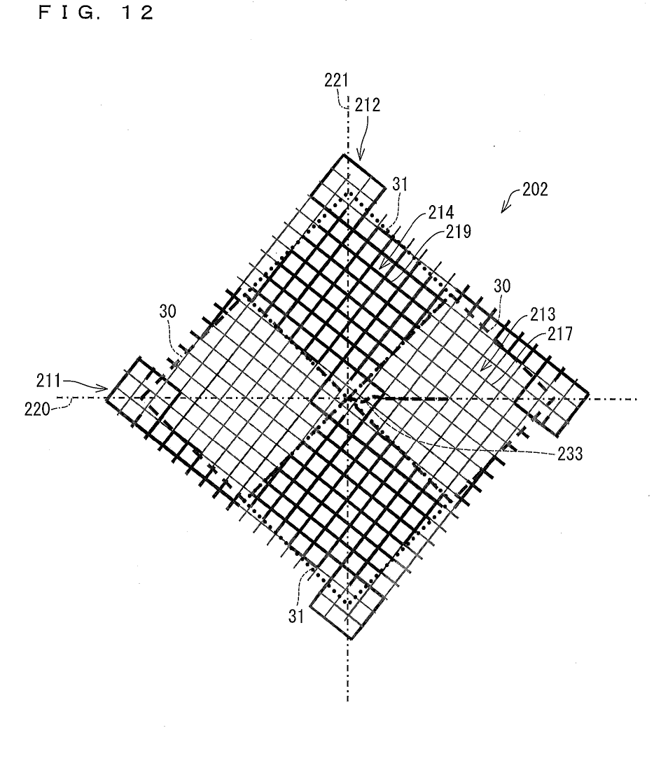

The following description will discuss, with reference to FIGS. 12 through 15, a touch panel substrate of another embodiment of the present invention. Note that, for convenience of description, members which have functions identical to those described in Embodiment 1 are given identical reference numerals, and descriptions on such members will be omitted.

<Touch Panel Substrate>

FIG. 12 is a plan view illustrating a configuration of a wire of the touch panel substrate 202 of the present embodiment.

A detection electrode of the touch panel substrate 202 of the present embodiment is configured such that symmetry of the detection electrode with respect to a sensor axis is high near a connection section between grid electrodes. This allows the touch panel substrate 202 to accurately detect a detection target with high positional accuracy.

As illustrated in FIG. 12, the touch panel substrate 202 of the present embodiment includes a first detection electrode 211 and a second detection electrode 212.

The first detection electrode 211 includes first grid electrodes 213 in each of which a first conductor line 217 is arranged, whereas the second detection electrode 212 includes second grid electrodes 214 in each of which a second conductor line 219 is arranged.

In the touch panel substrate 202 of the present embodiment, a first connection section pattern which is constituted by a square conductor line pattern is formed in the first detection electrode 211. Further, a second connection section pattern which is constituted by a square conductor line pattern is formed in the second detection electrode 212.

Accordingly, as is clear from a shape of the symmetry degree index line 233, symmetry, with respect to a sensor axis, of each of the first grid electrodes 213 is high near the connection section.

This will be discussed in more detail later.

<First Detection Electrode>

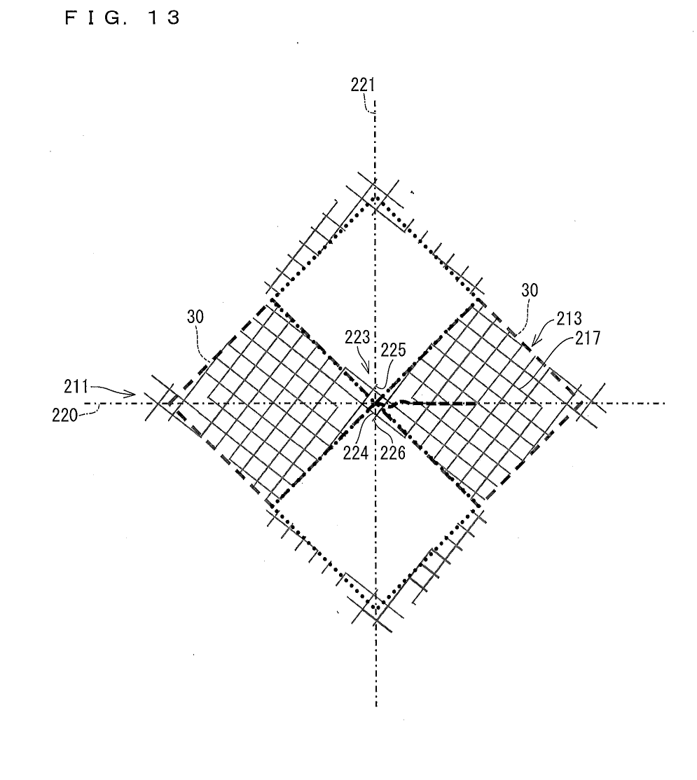

FIG. 13 is a plan view illustrating a detailed configuration of the first detection electrode 211 of the present embodiment.

A square indicated by a wavy line in FIG. 13 is a reference square 30 which indicates an outer shape of one of grid electrodes each of which has a square shape, in a case where each adjacent ones of the grid electrodes are provided on a straight line so as to share vertices with each other.

A sensor axis 220 illustrated in FIG. 13 is a straight line which (i) is parallel to a direction in which the first detection electrode 211 extends and (ii) equally divides an area of the reference square 30. The sensor axis 220 passes through two vertices of the reference square 30.

The first grid electrodes 213 of the present embodiment each have a substantially square shape. Each adjacent ones, in a direction in which the sensor axis 220 extends, of the first grid electrodes 213 are connected to each other by a first connection section 223 via vertices of outer shapes of the respective each adjacent ones of the first grid electrodes 213.

The first detection electrode 211 of the present embodiment includes the first connection section 223. The first connection section 223 includes a first connection section pattern 224 which (i) is constituted by a conductor line and (ii) has a grid shape.

Further, the first connection section pattern 224 has a square shape. In a plan view, a center of the first connection section pattern 224 overlaps with an intersection of the sensor axis 220 and the sensor axis 221. That is, the first connection section pattern 224 is constituted so as to surround the intersection of the sensor axis 220 and the sensor axis 221.

The first connection section pattern 224 has two branch lines. Each of the two branch lines is provided on an extension of a side constituting the first connection section pattern 224 and projects to an outside of the first connection section pattern 224.

The two branch lines are provided, in respective of an upper part and a lower part of the sensor axis 220, so as to be point-symmetric to each other with respect to the center of the first connection section pattern 224. In the following description, the branch line provided in the upper part and the branch line provided in the lower part are referred to as a first upper conductor line 225 and a first lower conductor line 226, respectively.

The first upper conductor line 225 and the first lower conductor line 226 can be each constituted by extending a corresponding first conductor line 217.

<Second Detection Electrode>

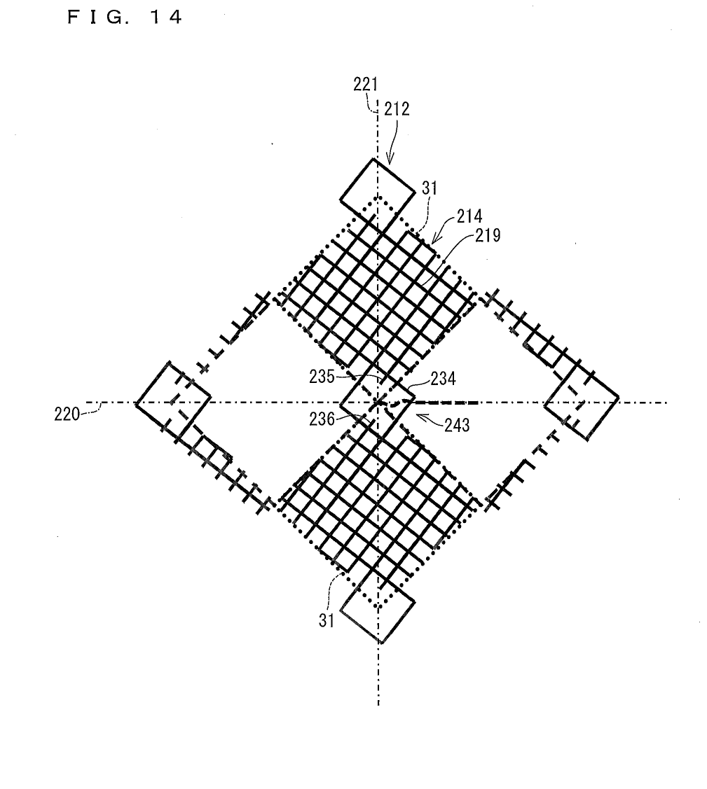

FIG. 14 is a plan view illustrating a detailed configuration of the second detection electrode 212 of the present embodiment.

A square indicated by a dotted line in FIG. 14 is a reference square 31 which indicates an outer shape of one of grid electrodes each of which has a square shape, in a case where each adjacent ones of the grid electrodes are provided on a straight line so as to share vertices with each other.

A sensor axis 221 illustrated in FIG. 14 is a straight line which (i) is parallel to a direction in which the second detection electrode 212 extends and (ii) equally divides an area of the reference square 31. The sensor axis 221 passes through two vertices of the reference square 31.

The second grid electrodes 214 of the present embodiment each have a substantially square shape. Each adjacent ones, in a direction in which the sensor axis 221 extends, of the second grid electrodes 214 are connected to each other by a second connection section 243 via vertices of outer shapes of the respective each adjacent ones of the second grid electrodes 214.

The second detection electrode 212 of the present embodiment includes the second connection section 243. The second connection section 243 includes a second connection section pattern 234 which (i) is constituted by a conductor line and (ii) has a grid shape.

Further, the second connection section pattern 234 has a square shape. In a plan view, a center of the second connection section pattern 234 overlaps with an intersection of the sensor axis 220 and the sensor axis 221. That is, the second connection section pattern 234 is constituted so as to surround the intersection of the sensor axis 220 and the sensor axis 221.

The second connection section pattern 234 has two branch lines. Each of the two branch lines is provided on an extension of a side constituting the second connection section pattern 234 and projects to an inside of the second connection section pattern 234.

The two branch lines are provided, in respective of an upper part and a lower part of the sensor axis 220, so as to be point-symmetric to each other with respect to the center of the second connection section pattern 234. In the following description, the branch line provided in the upper part and the branch line provided in the lower part are referred to as a second upper conductor line 235 and a second lower conductor line 236, respectively.

The second upper conductor line 235 and the second lower conductor line 236 can be each constituted by extending the second conductor line 219.

<Connection Section>

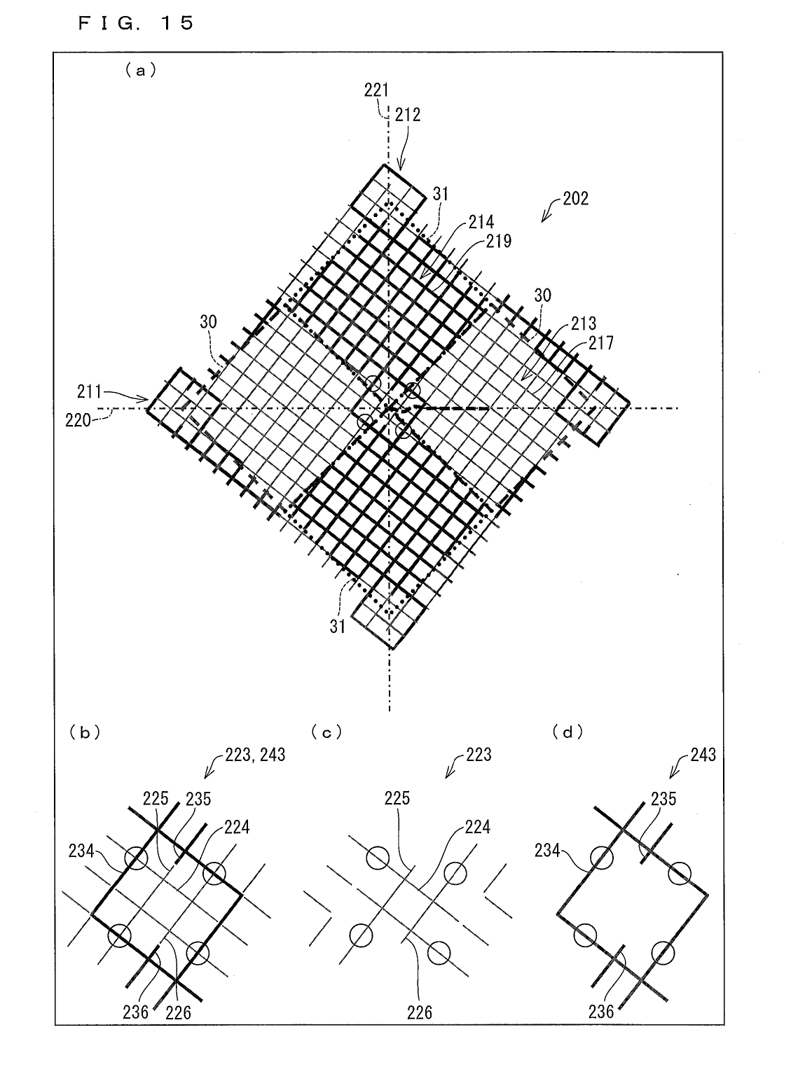

FIG. 15 is a plan view illustrating a configuration of a wire of the touch panel substrate 202 of the present embodiment. (a) of FIG. 15 is a plan view illustrating configurations of wires of the first detection electrode 211 and the second detection electrode 212. (b) of FIG. 15 is an enlarged plan view illustrating an intersection area between the first detection electrode 211 and the second detection electrode 212. (c) of FIG. 15 is an enlarged plan view illustrating the first connection section 223 of the first detection electrode. (d) of FIG. 15 is an enlarged plan view illustrating the second connection section 243 of the second detection electrode.

As illustrated in FIG. 15, the first detection electrode 211 and the second detection electrodes 212 form a uniform grid shape pattern in a plan view. Each unit grid has a square shape.

Further, according to the touch panel substrate 202 of the present embodiment, the first connection section pattern 224 is surrounded by the second connection section pattern 234 in a plan view.

According to the present embodiment, the first connection section pattern 224 has, in a plan view, a size identical to that of a unit grid forming a grid shape, whereas the second connection section pattern 234 is, in a plan view, nine times a size of a unit grid forming a grid shape. However, the sizes of the first connection section pattern 224 and the second connection section pattern 234 are not limited to this.

Note that parts where conductor lines of the first detection electrode 211 overlap with respective conductor lines of the second detection electrode 212 in a plan view (intersections in a plan view) exist in respective regions surrounded by circles indicated by solid lines in (a) and (b) of FIG. 15. In a plan view, the conductor lines of the first detection electrode 211 do not overlap with the respective conductor lines of the second detection electrode 212, except in these intersections.

That is, in a part where a mesh pattern of the first detection electrode 211 intersects, in a plan view, with a mesh pattern of the second detection electrode 212, the conductor lines of the first detection electrode 211 and the conductor lines of the second detection electrode 212 in a plan view overlap with each other only in the regions surrounded by the circles indicated by the solid lines in (a) and (b) of FIG. 15.

Circles indicated by solid lines in (c) and (d) of FIG. 15 correspond to respective circles indicated by solid lines in (b) of FIG. 15. As illustrated in (c) of FIG. 15, the conductor lines of the first detection electrode 211 continuously extend in the respective regions surrounded by the circles indicated by the solid lines. In contrast, outside the regions surrounded by the circles indicated by the solid lines, the conductor lines of the first detection electrode 211 are cut and thus do not continuously extend in parts where the conductor lines of the second detection electrode 212 are arranged to intersect (overlap) with the respective conductor lines of the first detection electrode 211.

When the first connection section 223 illustrated in (c) of FIG. 15 overlaps, in a plan view, with the second connection section 243 illustrated in (d) of FIG. 15, an intersection area between the first detection electrode 211 and the second detection electrode 212 is formed as illustrated in (b) of FIG. 15.

Note here that in each part where conductor lines of the first detection electrode 211 do not continuously extend in (c) of FIG. 15, it is preferable that a gap between the conductor lines of the first detection electrode 211 be not less than 30 μm. Note that according to the present embodiment, the gap between the conductor lines of the first detection electrode 211 is 50 μm.

This can reduce a parasitic capacity between the electrodes.

The conductor lines of the first detection electrode 211 and the conductor lines of the second detection electrode 212 are arranged such that a center (centroid) of the four intersections in a plan view becomes closer to the intersection of the sensor axis 220 and the sensor axis 221.

In other words, the intersections of the conductor lines of the first detection electrode 211 and the conductor lines of the second detection electrode 212 are uniformly arranged in a well-balanced manner around the intersection of the sensor axis 220 and the sensor axis 221.

This can prevent unevenness in a light transmittance near the intersection of the sensor axis 220 and the sensor axis 221.

(Branch Line)

As described above, in a plan view, the first detection electrode 211 and the second detection electrode 212 form a uniform grid shape pattern, and each unit grid has a square shape.

Further, according to the touch panel substrate 202 of the present embodiment, the first connection section pattern 224 and the second connection section pattern 234 each have two branch lines.

When the first connection section 223 overlaps, in a plan view, with the second connection section 243, the first upper conductor line 225 and the second upper conductor line 235 are arranged, in a plan view, on an identical straight line, whereas the first lower conductor line 226 and the second lower conductor line 236 are arranged, in a plan view, on an identical straight line.

The first upper conductor line 225 and the second upper conductor line 235 constitute a side of a unit grid. Further, the first lower conductor line 226 and the second lower conductor line 236 also constitute a side of a unit grid.

Such arrangements of the conductor lines allow the first detection electrode 211 and the second detection electrode 212 to form, in a plan view, a uniform grid shape pattern also near the connection sections 223 and 243.

This makes it possible to prevent an occurrence of unevenness in light transmitting quantity in a detection surface of the touch panel substrate 202.

Note that the first upper conductor line 225 and the second upper conductor line 235 are preferably arranged, in a plan view, on an identical straight line so as to have a gap of not less than 30 μm so that the first upper conductor line 225 and the second upper conductor line 235 do not overlap with each other in a plan view, as with the intersections, in a plan view, of the conductor lines of the first detection electrode 211 and the conductor lines of the second detection electrode 212.

According to the present embodiment, the first upper conductor line 225 and the second upper conductor line 235 are arranged, in a plan view, on an identical straight line so as to have a gap of 50 μm between the first upper conductor line 225 and the second upper conductor line 235.

Similarly, the first lower conductor line 226 and the second lower conductor line 236 are arranged, in a plan view, on an identical straight line so as to have a gap of 50 μm between the first lower conductor line 226 and the second lower conductor line 236.

(Symmetry with Respect to Sensor Axis)

By providing the first detection electrode 211 and the second detection electrode 212 in a manner described above in the touch panel substrate 202 of the present embodiment, it is possible to increase, near a connection section where grid electrodes are connected to each other, symmetry with respect to a sensor axis. The following description will specifically discuss this.

(Effective Area of Grid Electrode)

In the description of Embodiment 1, for simplification of description, the symmetry degree index line 33 obtained by connecting middle points to each other, each of which middle points is a middle point of two intersections of (i) the outer shape of each of the first grid electrodes 13 and (ii) a straight line vertical to the sensor axis 20, is described as an indicator of the symmetry with respect to the sensor axis

Note here that in order to more accurately describe the symmetry with respect to the sensor axis by using a symmetry degree index line, an effective area of each of the grid electrodes needs to be considered.

According to the touch panel substrate 202 of the present embodiment, in a plan view, (i) the conductor lines of the second detection electrode 212 are formed in respective regions of the first grid electrodes 213 so as to overlap with the first grid electrodes 213 and (ii) the conductor lines of the first detection electrode 211 are formed in respective regions of the second grid electrodes 214 so as to overlap with the second grid electrodes 214.

In a plan view, an effective area of each of the first grid electrodes 213 is considered as a region whose position is, in a region on the touch panel substrate 202, closer to the first conductor lines 217 than to the conductor lines of the second detection electrode 212.

In a plan view, an effective area of each of the second grid electrodes 214 is considered as a region whose position is, in the region on the touch panel substrate 202, closer to the second conductor lines 219 than to the conductor lines of the first detection electrode 211.

Further, the symmetry degree index line 233 is a line obtained by connecting, along the sensor axis 220, positions of centroids of respective effective areas of the first grid electrodes 213 in a direction vertical to the sensor axis 220.

In a case where the symmetry degree index line 233 is located on the sensor axis 220, the effective areas of the first grid electrodes 213 are linearly symmetric with respect to the sensor axis 220.

(Symmetry of First Grid Electrode with Respect to Sensor Axis)

When the symmetry degree index line 133 of the touch panel substrate 102 of the Embodiment 1 illustrated in FIG. 8 is compared with the symmetry degree index line 233 of the touch panel substrate 202 of the present embodiment illustrated in FIG. 15, the symmetry degree index line 233 is, as compared with the symmetry degree index line 133, closer to the sensor axis.

That is, the symmetry, with respect to the sensor axis, of each of the first grid electrodes 213 of Embodiment 2 is higher than the symmetry, with respect to the sensor axis, of each of the first grid electrodes 113 of Embodiment 1.

This allows the touch panel substrate 202 of the present embodiment to more accurately detect a position of a detection target.

Note here that the first upper conductor line 225, the first lower conductor line 226, the second upper conductor line 235, and the second lower conductor line 236 contribute to an increase in symmetry with respect to the sensor axis.

That is, in a case where the first upper conductor line 225 and the first lower conductor line 226 are provided, the symmetry, with respect to the sensor axis, of each of the first grid electrodes 213 is higher, as compared with a case where (i) the first upper conductor line 225 and the first lower conductor line 226 are not provided and (ii) instead, the conductor lines of the second detection electrode 212 are provided in corresponding positions.

In a case where, as in the touch panel substrate of the present embodiment, the first connection section pattern 224 is surrounded by the second connection section pattern 234 in a plan view, the first upper conductor line 225 and the first lower conductor line 226 for increasing the symmetry with respect to the sensor axis can be formed in the second connection section pattern 234.

That is, according to the touch panel substrate 102 of Embodiment 1, in order to form a branch line in the conductor line of the connection section of the first detection electrode while maintaining the grid shape of the conductor line, it is necessary to cut the two conductor lines constituting the connection section of the second grid electrode.

In contrast, according to the touch panel substrate 202 of the present embodiment, the conductor line (second connection section pattern 234) of the second connection section 243 of the second detection electrode 212 detours so as to surround the first connection section pattern 224 of the first detection electrode 211. This makes it possible to provide a branch line without cutting the conductor line of the connection section of the second detection electrode 212.

Accordingly, a branch line for increasing the symmetry, with respect to the sensor axis, of each of the grid electrodes near the connection section where the grid electrodes are connected to each other can be provided while an electrical connection between the grid electrodes is maintained.

This makes it possible to increase an accuracy of position detection of the touch panel substrate.

Further, the touch panel substrate of an example of Embodiment 1 and the touch panel substrate of Embodiment 2 can prevent an occurrence of a moire, as with the touch panel substrate of the reference example.

### CONCLUSION

A touch panel substrate in accordance with a first aspect of the present invention includes: a plurality of first detection electrodes each of which extends in a direction parallel to a first direction; and a plurality of second detection electrodes each of which extends in a direction parallel to a second direction which differs from the first direction, the plurality of first detection electrodes each including (i) a plurality of first grid electrodes which are arranged in a direction parallel to the first direction and each of which has an outer shape that is substantially quadrilateral and (ii) a first connection section which causes each adjacent ones of the plurality of first grid electrodes in the first direction to be connected to each other, the plurality of second detection electrodes each include (i) a plurality of second grid electrodes which are arranged in a direction parallel to the second direction and each of which has an outer shape that is substantially quadrilateral and (ii) a second connection section which causes each adjacent ones of the plurality of second grid electrodes in the second direction to be connected to each other, the plurality of first grid electrodes each including a first conductor line having a grid shape, the plurality of second grid electrodes each including a second conductor line having a grid shape, one of diagonal lines of a single grid that forms the grid shape of the first conductor line being inclined by θ degrees with respect to the first direction, the other of the diagonal lines being inclined by θ degrees with respect to a direction vertical to the first direction, one of diagonal lines of a single grid that forms the grid shape of the second conductor line being inclined by θ degrees with respect to the second direction, the other of the diagonal lines being inclined by θ degrees with respect to a direction vertical to the second direction, a first connection section pattern which has a grid shape and includes a conductor line being provided in the first connection section, a second connection section pattern which has a grid shape and includes a conductor line being provided in the second connection section, in a plan view, the first connection section pattern being located inside the second connection section pattern.

With the arrangement above, a pattern of positional arrangement of intersections of first conductor lines is not parallel to a first electrode axis.

Generally, in a case where a touch panel substrate is provided on a display surface of a display panel including (i) a black matrix which is arranged in matrix and (ii) a TFT, a pattern of positional arrangement of intersections of first conductor lines interferes with a pattern of arrangement of the black matrix or the like. This causes an occurrence of a moire, so as to cause deterioration in display quality.

In contrast, even in a case where the touch panel substrate of the present invention is provided on the display surface of the display panel such that the first electrode axis is parallel to the pattern of arrangement of the black matrix or the like, the pattern of positional arrangement of the intersections of the first conductor lines does not interfere with the pattern of arrangement of the black matrix or the like.

This makes it possible to prevent an occurrence of a moire, so as to prevent deterioration in display quality.

Further, the touch panel substrate of the present invention is arranged such that, in a plan view, the first connection section pattern is located inside the second connection section pattern.

Accordingly, it is possible to increase symmetry with respect to a sensor axis, (i) in the first connection section of each of the plurality of first grid electrodes and the second connection section of each of the plurality of second grid electrodes and (ii) near the first connection section and the second connection section. This prevents deterioration in accuracy of detection which deterioration is caused by unevenness in shapes of the plurality of first grid electrodes with respect to the sensor axis (first electrode axis).

In a second aspect of the present invention, the touch panel substrate in accordance with the first aspect of the present invention can be arranged such that the first connection section pattern includes a first upper conductor line and a first lower conductor line each of which projects to an outside of the first connection section pattern; the second connection section pattern includes a second upper conductor line and a second lower conductor line each of which projects to an inside of the second connection section pattern; the first upper conductor line and the first lower conductor line are provided point-symmetrically to each other with respect to a center of the first connection section patter; and the second upper conductor line and the second lower conductor line are provided point-symmetrically to each other with respect to a center of the second connection section pattern.

With the arrangement above, it is possible to further increase the symmetry with respect to the sensor axis, (i) in the first connection section of each of the plurality of first grid electrodes and the second connection section of each of the plurality of second grid electrodes and (ii) near the first connection section and the second connection section. This further prevents deterioration in accuracy of detection which deterioration is caused by unevenness in shapes of the plurality of first grid electrodes with respect to the sensor axis (first electrode axis).

In a third aspect of the present invention, the touch panel substrate in accordance with the second aspect of the present invention can be arranged such that in a plan view, the plurality of first detection electrodes and the plurality of second detection electrodes form a uniform grid shape pattern.

With the arrangement above, light transmitting quantity can be uniformized in a detection surface of the touch panel substrate.

In a fourth aspect of the present invention, the touch panel substrate in accordance with the third aspect of the present invention can be arranged such that in a plan view, (i) the first upper conductor line and the second upper conductor line form a side of a grid which is a minimum unit of the grid shape pattern and (ii) the first lower conductor line and the second lower conductor line form a side of a grid which is a minimum unit of the grid shape pattern.

In a fifth aspect of the present invention, the touch panel substrate in accordance with any one of the first through fourth aspects of the present invention can be arranged such that the plurality of first grid electrodes are arranged along a first electrode axis which extends in a direction parallel to the first direction; the plurality of second grid electrodes are arranged along a second electrode axis which extends in a direction parallel to the second direction; and in a plan view, an intersection of the first electrode axis and the second electrode axis overlaps with a center of the first connection section pattern and a center of the second connection section pattern.

With the arrangement above, it is possible to further increase, near the intersection of the sensor axes (the first electrode axis and the second electrode axis), the symmetry with respect to the sensor axis.

In a sixth aspect of the present invention, the touch panel substrate in accordance with the fifth aspect of the present invention can be arranged such that the plurality of first grid electrodes are arranged along the first electrode axis in each of the plurality of first detection electrodes; the plurality of second grid electrodes are arranged along the second electrode axis in each of the plurality of second detection electrodes; the first electrode axis is an axis of symmetry for vertices of a pair of opposite angles of an outer shape of each of the plurality of first grid electrodes; and the second electrode axis is an axis of symmetry for vertices of a pair of opposite angles of an outer shape of each of the plurality of second grid electrodes.

It is possible to increase the symmetry with respect to the sensor axis also in a part other than near the intersection of the sensor axes (the first electrode axis and the second electrode axis).

In a seventh aspect of the present invention, the touch panel substrate in accordance with any one of the first through sixth aspects of the present invention can be arranged such that the each adjacent ones, in the first direction, of the plurality of first grid electrodes are connected to each other by the first connection section via vertices of the outer shapes of the respective each adjacent ones of the plurality of first grid electrodes; and the each adjacent ones, in the second direction, of the plurality of second grid electrodes are connected to each other by the second connection section via vertices of the outer shapes of the respective each adjacent ones of the plurality of second grid electrodes.

In an eighth aspect of the present invention, the touch panel substrate in accordance with any one of the first through seventh aspects of the present invention can be arranged such that in a plan view, the first connection section pattern has a size identical to that of the single grid which forms the grid shape; and in a plan view, the second connection section pattern has a size nine times as large as that of the single grid which forms the grid shape.

In a ninth aspect of the present invention, the touch panel substrate in accordance with any one of the first through eighth aspects of the present invention can be arranged such that the first direction and the second direction are orthogonal to each other.

In a tenth aspect of the present invention, the touch panel substrate in accordance with any one of the first through ninth aspects of the present invention can be arranged such that (i) the first connection section pattern of the first connection section is point symmetrical with respect to a center of the first connection section pattern and (ii) the first conductor lines of the respective adjacent ones of the plurality of first grid electrodes, which are connected to each other via the first connection section, are point-symmetrical to each other with respect to the center of the first connection section pattern; and (i) the second connection section pattern of the second connection section is point symmetrical with respect to a center of the second connection section pattern and (ii) the second conductor lines of the respective adjacent ones of the plurality of second grid electrodes, which are connected to each other via the second connection section, are point-symmetrical to each other with respect to the center of the second connection section pattern.

In order to attain the object, a display device in accordance with an eleventh aspect of the present invention includes: a touch panel substrate recited in any one of the first through tenth aspects; and a display panel.

In a twelfth aspect of the present invention, the touch panel substrate in accordance with the eleventh aspect of the present invention can be arranged such that the display panel includes a black matrix which is arranged in matrix; and the first direction is parallel to a direction of arrangement of the black matrix.

With the arrangement above, it is possible to provide, without arranging a touch panel substrate to be inclined with respect to a display panel, a display device in which an occurrence of a moire is prevented so that deterioration in display quality is prevented.

In a case where a direction in which detection electrodes each extend is arranged to be inclined with respect to a display panel, one or more wires of each of the detection electrodes are not arranged on a front surface of the display panel. That is, a loss occurs in first detection electrodes.

In contrast, according to the present invention, it is possible to provide, without causing such a loss, a display device in which deterioration in display quality is prevented.

The present invention is not limited to the description of the embodiments above, but may be altered by a skilled person in the art within the scope of the claims. An embodiment based on a proper combination of technical means disclosed in different embodiments is encompassed in the technical scope of the present invention. Moreover, a new technical feature can be obtained from a proper combination of technical means disclosed in different embodiments.

### INDUSTRIAL APPLICABILITY

The present invention is applicable to a display device having a touch panel function.

### REFERENCE SIGNS LIST

1: Display device
2, 102, 202: Touch panel substrate
10: Black matrix
11, 111, 211: First detection electrode
12, 112, 212: Second detection electrode
13, 113, 213: First grid electrode
14, 114, 214 Second grid electrode
20, 120, 220: Sensor axis (first electrode axis)
21, 121, 221: Sensor axis (second electrode axis)
117, 217: First conductor line
119, 219: Second conductor line
223: First connection section
224: First connection section pattern
225: First upper conductor line
226: First lower conductor line
234: Second connection section pattern
235: Second upper conductor line
236: Second lower conductor line
243: Second connection section

1. A touch panel substrate, comprising:
a plurality of first detection electrodes each of which extends in a direction parallel to a first direction; and
a plurality of second detection electrodes each of which extends in a direction parallel to a second direction which differs from the first direction,
the plurality of first detection electrodes each including (i) a plurality of first grid electrodes which are arranged in a direction parallel to the first direction and each of which has an outer shape that is substantially quadrilateral and (ii) a first connection section which causes each adjacent ones of the plurality of first grid electrodes in the first direction to be connected to each other,
the plurality of second detection electrodes each include (i) a plurality of second grid electrodes which are arranged in a direction parallel to the second direction and each of which has an outer shape that is substantially quadrilateral and (ii) a second connection section which causes each adjacent ones of the plurality of second grid electrodes in the second direction to be connected to each other,
the plurality of first grid electrodes each including a first conductor line having a grid shape,
the plurality of second grid electrodes each including a second conductor line having a grid shape,
one of diagonal lines of a single grid that forms the grid shape of the first conductor line being inclined by θ degrees with respect to the first direction, the other of the diagonal lines being inclined by θ degrees with respect to a direction vertical to the first direction,
one of diagonal lines of a single grid that forms the grid shape of the second conductor line being inclined by θ degrees with respect to the second direction, the other of the diagonal lines being inclined by θ degrees with respect to a direction vertical to the second direction,
a first connection section pattern which has a grid shape and includes a conductor line being provided in the first connection section,
a second connection section pattern which has a grid shape and includes a conductor line being provided in the second connection section,
in a plan view, the first connection section pattern being located inside the second connection section pattern.

2. The touch panel substrate as set forth in claim 1, wherein:
the first connection section pattern includes a first upper conductor line and a first lower conductor line each of which projects to an outside of the first connection section pattern;
the second connection section pattern includes a second upper conductor line and a second lower conductor line each of which projects to an inside of the second connection section pattern;
the first upper conductor line and the first lower conductor line are provided point-symmetrically to each other with respect to a center of the first connection section patter; and
the second upper conductor line and the second lower conductor line are provided point-symmetrically to each other with respect to a center of the second connection section pattern.

3. The touch panel substrate as set forth in claim 2, wherein in a plan view, the plurality of first detection electrodes and the plurality of second detection electrodes form a uniform grid shape pattern.

4. The touch panel substrate as set forth in claim 3, wherein in a plan view, (i) the first upper conductor line and the second upper conductor line form a side of a grid which is a minimum unit of the grid shape pattern and (ii) the first lower conductor line and the second lower conductor line form a side of a grid which is a minimum unit of the grid shape pattern.

5. The touch panel substrate as set forth in claim 1, wherein:
the plurality of first grid electrodes are arranged along a first electrode axis which extends in a direction parallel to the first direction;
the plurality of second grid electrodes are arranged along a second electrode axis which extends in a direction parallel to the second direction; and
in a plan view, an intersection of the first electrode axis and the second electrode axis overlaps with a center of the first connection section pattern and a center of the second connection section pattern.

6. The touch panel substrate as set forth in claim 5, wherein:
the plurality of first grid electrodes are arranged along the first electrode axis in each of the plurality of first detection electrodes;
the plurality of second grid electrodes are arranged along the second electrode axis in each of the plurality of second detection electrodes;
the first electrode axis is an axis of symmetry for vertices of a pair of opposite angles of an outer shape of each of the plurality of first grid electrodes; and
the second electrode axis is an axis of symmetry for vertices of a pair of opposite angles of an outer shape of each of the plurality of second grid electrodes.

7. The touch panel substrate as set forth in claim 1, wherein:
the each adjacent ones, in the first direction, of the plurality of first grid electrodes are connected to each other by the first connection section via vertices of the outer shapes of the respective each adjacent ones of the plurality of first grid electrodes; and
the each adjacent ones, in the second direction, of the plurality of second grid electrodes are connected to each other by the second connection section via vertices of the outer shapes of the respective each adjacent ones of the plurality of second grid electrodes.

8. The touch panel substrate as set forth in claim 1, wherein:
in a plan view, the first connection section pattern has a size identical to that of the single grid which forms the grid shape; and
in a plan view, the second connection section pattern has a size nine times as large as that of the single grid which forms the grid shape.

9. The touch panel substrate as set forth in claim 1, wherein the first direction and the second direction are orthogonal to each other.

10. The touch panel substrate as set forth in claim 1, wherein:
(i) the first connection section pattern of the first connection section is point symmetrical with respect to a center of the first connection section pattern and (ii) the first conductor lines of the respective adjacent ones of the plurality of first grid electrodes, which are connected to each other via the first connection section, are point-symmetrical to each other with respect to the center of the first connection section pattern; and
(i) the second connection section pattern of the second connection section is point symmetrical with respect to a center of the second connection section pattern and (ii) the second conductor lines of the respective adjacent ones of the plurality of second grid electrodes, which are connected to each other via the second connection section, are point-symmetrical to each other with respect to the center of the second connection section pattern.

11. A display device, comprising:
a touch panel substrate recited in claim 1; and
a display panel.

12. The display device as set forth in claim 11, wherein:
the display panel includes a black matrix which is arranged in matrix; and
the first direction is parallel to a direction of arrangement of the black matrix.
